(19) United States
(12) Patent Application Publication
(10) Pub. No.: US 2021/0378445 A1
(43) Pub. Date: Dec. 9, 2021

(54) CONTACT GRILL WITH PASSIVE SMOKE REDUCTION

(71) Applicant: Spectrum Brands, Inc., Middleton, WI (US)

(72) Inventors: Firdaus Sameer Nandoliya, Verona, WI (US); Maciej Murzynski, Verona, WI (US); Boopalan Sampath, Madison, WI (US); Jacob Daniel Smith, Monona, WI (US)

(21) Appl. No.: 17/282,473

(22) PCT Filed: Oct. 3, 2019
(86) PCT No.: PCT/US2019/054504

§ 371 Date: Apr. 2, 2021

Related U.S. Application Data
(60) Provisional application No. 62/741,328, filed on Oct. 4, 2018.

(51) Int. Cl. A47J 37/06; A47J 36/32; A47J 36/38; F24C 15/20; F24C 15/14

(52) U.S. Cl. CPC A47J 37/0611; A47J 36/32; A47J 2202/00; F24C 15/2042; F24C 15/14; A47J 36/38

(57) ABSTRACT

Contact grill designs with features that reduce the production of smoke and that otherwise diffuse smoke to reduce the visibility of the smoke as such smoke made up of a combination of steam and burned grease is generated during the cooking of a food product such as a meat product. Contact grills make use of passive air flow in one or both of upper and lower grill housings to reduce production of smoke and to better diffuse smoke to reduce smoke visibility exiting a cooking chamber of the contact grill.

### PRIORITY CLAIM

This application claims the benefit of U.S. Provisional Patent Application Ser. No. 62/741,328, filed Oct. 4, 2018, the disclosure of which is incorporated in its entirety herein by reference.

### TECHNICAL FIELD

The present invention is directed to contact grills and in particular to improved contact grills with reduced smoke emission as food products are cooked.

### BACKGROUND

A contact grill generally comprises upper and lower grill plates that are typically housed within upper and lower housings, respectively, that are hinged together. Each of the grill plates can be controllably heated. As such, a food product, for example one or more burgers, can be cooked by being placed on the lower grill plate surface, the upper grill plate then lowered onto and in substantially full contact with the food product, while the grill plates are heated. Contact grills are defined by the ability to cook both sides of a food product at the same time by a set of movable grill plates. Typically, the heating elements are electrical resistive heating elements such as cal-rod heating elements as are themselves well known.

Typically also, the upper and lower housings are hinged together by way of a floating hinge that allows the contact grill to accommodate different thickness food products and enhances the ability of the upper grill plate to lie on the food product to substantially be in full contact with the food product. George Foreman® grills are a popular type of contact grill, which grills are sold and manufactured by Spectrum Brands, Inc. of Middleton, Wis., the assignee of the subject invention.

Contact grills are designed to be used primarily as a kitchen item, so similar to cooking a burger on a frying pan, the smoke generated during cooking resides within the kitchen. Specifically in the case of a contact grill, the smoke exits the contact grill along its sides or the back. It is noted that, in the case of cooking meat, smoke generally comprises a combination of steam from the water in the meat and burned fat also from the meat. In the case of ground beef as a burger, the steam is likely to comprise most of the smoke that exits the grill during a cooking cycle.

Unlike using a frying pan for cooking a burger, as an example, in a contact grill provided with a sloped design, the meat fat from the burger is typically run from the cooking surface of the lower grill plate in particular so as to flow into a grease collection tray or drip tray. Less grease left residing on a heated cooking surface generates less smoke from the burning of the meat fat. Sloped contact grills usually include both the upper and lower grill plates being supported at an angle or around 5 to 10 degrees to the front edge of the unit with the drip tray located adjacent to the front edge of the lower grill plate.

### SUMMARY

The present invention is directed to contact grill designs with features that reduce the production of smoke on the one hand and that otherwise diffuse smoke to reduct the visibility of the smoke on the other hand as such smoke (steam and burned grease) is generated during the cooking of a food product such as a meat product. Contact grills of the present invention make use of passive air flow in one or both of upper and lower grill housings to reduce production of smoke and to better diffuse smoke to reduce smoke visibility exiting a cooking chamber of the contact grill.

Fluid (ambient air) flow through the upper housing can comprise fluid flow from the cooking chamber through or around an upper grill plate. Moreover, supplemental fluid flow into and out of the upper housing can also be advantageously facilitated for diffusing generated smoke from the cooking chamber. Fluid flow through the lower housing can allow ambient air, for example, to enter into the lower housing. That air can then be drawn into the cooking chamber by natural convective fluid flow as the cooking chamber is heated, which fluid flow can cool the environment within the lower housing below a lower grill plate as well as provide fluid flow into the cooking chamber for diffusing generated smoke. Cooling the environment within the lower housing allows grease to be collected below the lower grill plate by a grease tray, for example, without the grease being burned within the grease tray to reduce grease smoke generation.

In one aspect, the present invention is directed to a contact grill that comprises a lower housing including a lower grill plate and a lower heating element for controlled heating of the lower grill plate, the lower heating element electrically connected with a temperature control circuit, an upper housing including an upper grill plate and an upper heating element for controlled heating of the upper grill plate, the upper heating element electrically connected with the temperature control circuit; and a hinge operatively connecting the lower and upper housings and permitting movement of the lower and upper housings relative to one another for allowing one or more food items to be placed in contact with the lower and upper grill plates and creating a cooking chamber. The upper housing being is advantageously vented to permit fluid flow there-through from the cooking chamber to external of the upper housing. The upper housing can also comprise at least one exit opening from an internal volume between the upper grill plate and the upper housing, a least one air inlet opening positioned lower than the exit opening, and at least one opening allowing fluid flow from the cooking chamber into the upper housing chamber.

The contact grill is vented so that during a cooking cycle, the opening from the cooking chamber into the internal volume of the upper housing allows passive flow of heated fluid from the cooking chamber into the internal volume of the upper housing and subsequently fluid flow from the internal volume by way of the exit opening as a first upper fluid flow path and further wherein the fluid flow through the internal volume of the upper housing passively draws ambient air into the internal volume of the upper housing by way of the inlet opening thus creating a second upper fluid flow path. Preferably, the fluid flow of the heated fluid from the cooking chamber into the internal volume of the upper housing also causes a fluid flow into the cooking chamber.

The lower housing can also include an access opening into the inside of the lower housing and the lower grill plate includes at least one opening so that a lower fluid flow path can be created by passively drawing air into the cooking chamber. Plural openings can be provided from the cooking chamber into the internal volume of the upper housing preferably with the plural openings arranged outside of a cooking contact zone of the upper grill plate. Plural exit openings and plural inlet openings of the upper housing can also be provided, wherein each of the exit openings can be preferably positioned above each of the inlet openings. The upper grill plate can include a pattern of openings provided through the upper grill plate. Likewise, the lower grill plate can include a pattern of openings provided through the lower grill plate. A sliding barrier can also be incorporated between the upper and lower housings for limiting air flow into the cooking chamber from the front, sides, and back of the contact grill. Such a sliding barrier can comprise an extension element from one of the upper and lower grill plates or housings and a recess element from the other of the upper and lower grill plates or housings so that air flow is restricted over a range of separation of the upper and lower grill plates from one another.

In another aspect of the present invention, a contact grill is provided that comprises a lower housing including a lower grill plate and a lower heating element for controlled heating of the lower grill plate, the lower heating element electrically connected with a temperature control circuit, an upper housing including an upper grill plate and an upper heating element for controlled heating of the upper grill plate, the upper heating element electrically connected with the temperature control circuit; and a hinge operatively connecting the lower and upper housings and permitting movement of the lower and upper housings relative to one another for allowing one or more food items to be placed in contact with the lower and upper grill plates and creating a cooking chamber. The lower housing can include an access opening to the inside of the lower housing and the lower grill plate can preferably include at least one opening so that air can flow into the lower housing and out from the opening of the lower grill plate into the cooking chamber. The lower housing can also include a drip pan removably located therein.

The upper housing of the contact grill is preferably vented to permit fluid flow there-through from the cooking chamber to external of the upper housing and the upper housing can comprise at least one exit opening from an internal volume between the upper grill plate and the upper housing, a least one air inlet opening positioned lower than the exit opening, and at least one opening allowing fluid flow from the cooking chamber into the upper housing chamber. The upper housing is thus vented so that during a cooking cycle, the opening from the cooking chamber into the internal volume of the upper housing allows passive flow of heated fluid from the cooking chamber into the internal volume of the upper housing and subsequently fluid flow from the internal volume by way of the exit opening as a first upper fluid flow path. The fluid flow through the internal volume of the upper housing can passively draw ambient air into the internal volume of the upper housing by way of the inlet opening thus creating a second upper fluid flow path. Moreover, the fluid flow of the heated fluid from the cooking chamber into the internal volume of the upper housing can thus also cause a fluid flow into the cooking chamber.

The lower housing can also include an access opening into the inside of the lower housing and the lower grill plate can include at least one opening so that a lower fluid flow path can be created by passively drawing air into the cooking chamber. Plural openings can be provided from the cooking chamber into the internal volume of the upper housing preferably with the plural openings arranged outside of a cooking contact zone of the upper grill plate. Plural exit openings and plural inlet openings of the upper housing can also be provided, wherein each of the exit openings can be preferably positioned above each of the inlet openings. The upper grill plate can include a pattern of openings provided through the upper grill plate. Likewise, the lower grill plate can include a pattern of openings provided through the lower grill plate. A sliding barrier can also be incorporated between the upper and lower housings for limiting air flow into the cooking chamber from the front, sides, and back of the contact grill. Such a sliding barrier can comprise an extension element from one of the upper and lower grill plates or housings and a recess element from the other of the upper and lower grill plates or housings so that air flow is restricted over a range of separation of the upper and lower grill plates from one another.

In yet another aspect, the present invention is directed to a contact grill that comprises a lower housing including a lower grill plate and a lower heating element for controlled heating of the lower grill plate, the lower heating element electrically connected with a temperature control circuit, an upper housing including an upper grill plate and an upper heating element for controlled heating of the upper grill plate, the upper heating element electrically connected with the temperature control circuit, and a hinge operatively connecting the lower and upper housings and permitting movement of the lower and upper housings relative to one another for allowing one or more food items to be placed in contact with the lower and upper grill plates and creating a cooking chamber. Preferably, the upper housing is vented to permit fluid flow there-through from the cooking chamber to external of the upper housing. Moreover, the upper housing can comprise at least one exit opening from an internal volume between the upper grill plate and the upper housing, a least one air inlet opening positioned lower than the exit opening, and at least one opening allowing fluid flow from the cooking chamber into the upper housing chamber. More preferably, the lower housing can include an access opening to the inside of the lower housing and the lower grill plate can include at least one opening so that air can flow into the lower housing and out from the opening of the lower grill plate into the cooking chamber. The lower housing can also include a drip pan removably located therein.

### BRIEF DESCRIPTION OF THE DRAWINGS

FIG. 1 is a perspective view of a contact grill in accordance with the present invention showing an upper housing and grill plate in an open position provided with openings for creating a partial fluid flow path through the upper housing;

FIG. 2 is a perspective view of the contact grill of FIG. 1 showing the upper housing and grill plate in a closed position provided with openings for creating a partial fluid flow path through the upper housing;

FIG. 3 is a perspective view of the contact grill of FIG. 1 with the upper and lower grill plates removed to show upper and lower heating elements within internal volumes of the upper and lower housings;

FIG. 4 is a perspective view of the upper housing as in FIG. 3 along with the upper grill plate removed from the upper housing;

FIG. 5 is a perspective view of another contact grill of the present invention including an upper housing and upper grill plate in an open position and with a lower housing and a lower grill plate provided with openings for creating a partial fluid flow path through the lower housing;

FIG. 6 is a perspective view of yet another contact grill in accordance with the present invention showing an upper housing and upper grill plate in an open position provided with openings for creating a partial fluid flow path through the upper housing and a lower housing and a lower grill plate provided with openings for creating a partial fluid flow path through the lower housing;

FIG. 7 is a view similar to FIG. 6 but of a slightly different orientation and showing a filter media provided within the upper housing above the upper grill plate;

FIG. 8 is a perspective view of the upper housing of FIG. 7 with the upper grill plate removed to show an embodiment of filter media provided within the upper housing;

FIG. 9 is yet another contact grill in accordance with the present invention similar to FIG. 6 but with the openings through the upper grill plate provided outside of a cooking zone of the upper grill plate;

FIG. 10 is a perspective view of the contact grill of FIG. 9 with the upper housing open and showing an upper shield that may be provided between the upper heating element and the upper housing;

FIG. 11 is a perspective view of yet another contact grill in accordance with the present invention showing an upper housing and upper grill plate in a closed position provided with an elongate opening and a series of venting openings for creating a partial fluid flow path through the upper housing and a lower housing and a lower housing provided with a front opening for creating a partial fluid flow path through the lower housing; and

FIG. 12 is a cross sectional view of the contact grill of FIG. 12 showing a cooking chamber provided between the upper and lower grill plates and a sliding barrier provided by features of the upper and lower grill plates.

### DETAILED DESCRIPTION

The present invention is directed to contact grill designs with features that reduce the production of smoke on one hand and that otherwise diffuse smoke to reduce the visibility of the smoke on the other hand as such smoke is generated during a food cooking process. As above, smoke is generated during cooking as a combination of steam and burned fat when cooking food products, such as meats as such meats typically include a content of animal fat and water. With ground beef, the water content can create a greater quantity of steam during cooking than smoke generated from burning fat.

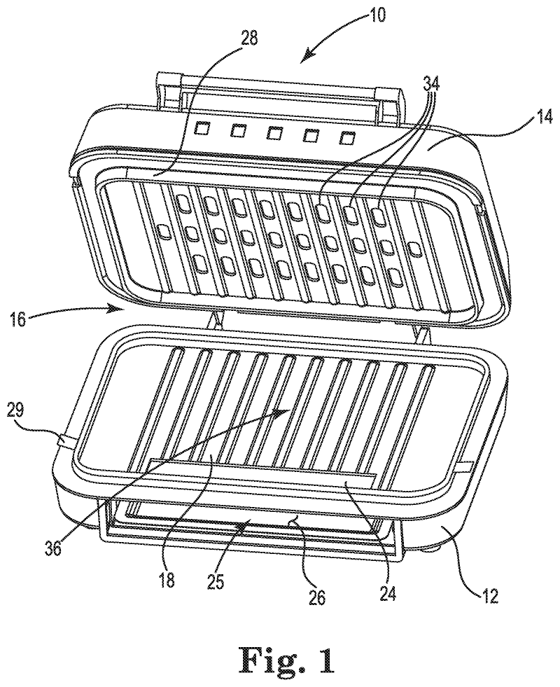

FIG. 1 shows a contact grill 10 comprising a lower housing 12, an upper housing 14, and a hinge assembly 16 that allows pivot movement of the upper housing 14 to the lower housing 12. The hinge assembly preferably also allows translational movement of the upper housing 14 relative to the lower housing 12 to allow the spacing between the upper and lower housings 14, 12 to be varied to accommodate different thickness food products. The hinge assembly 16 is preferably what is known as a floating hinge, as such floating hinges are known in the design of contact grills of the prior art. One such hinge assembly is described, for example, within U.S. Pat. No. 9,901,209 to Guckenberger et al, which patent is incorporated by reference in its entirety.

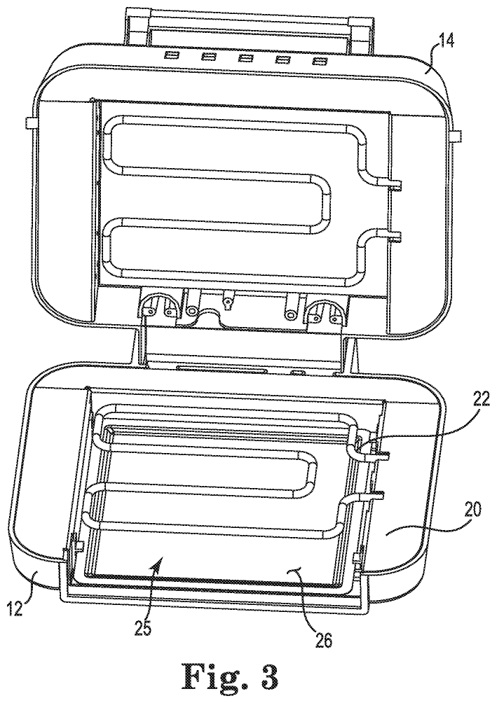

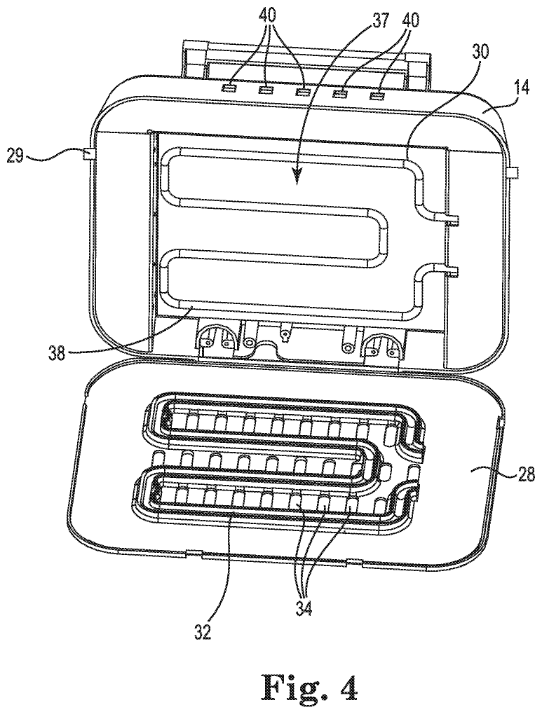

A lower grill plate 18 is operatively supported to the lower housing 12, such as by an upper peripheral surface portion 20 of the lower housing 12, as shown in FIG. 3. The lower grill plate 18 is preferably easily removable from the lower housing 12 for easy cleaning and can be held in place and rendered removable by a mechanical latch assembly, such as a spring clip or the like as such fasteners are conventionally known. The lower grill plate 18 is preferably in conductive contact with a heating element 22 that preferably fits within a complimentary groove or channel on the bottom of the lower grill plate 18 that may be formed integrally with the lower grill plate 18 (see FIG. 4 for a similar groove of the upper grill plate discussed in detail below). The groove or channel can be utilized for proper positioning of the lower grill plate 18 to the lower housing 12 and also functions to shield the heating element 22 from direct contact with grease while also enhancing conductive heat transfer. The lower heating element 22 is preferably a cal-rod type heating element, which is an electrical resistance type heating element. Other heating elements are contemplated including those that conductive, convective and/or radiant energy to heat the lower grill plate 18 in accordance with the present invention.

Referring back to FIG. 1, the lower grill plate is shown with a grease exit slot 24 that opens to a drip tray 26 that can be supported below the lower grill plate 18. The drip tray 26 can be supported to the lower housing 12, such as by sliding guide surface along plural opposed sides of the drip tray 26 or by sitting on the bottom of the lower housing 12. A front opening 25 of the lower housing 12 allows for access to the drip tray 26 from the front of the contact grill 10. This design could alternatively have a conventional drip tray at the front edge of the lower grill plate 18 and the grease exit slot 24 and front opening 25 could be eliminated. In any case, it is preferable that at least the lower grill plate 18 be supported at an angle to induce grease flow to the slot 24 or other grease drip tray as provided. It is noted that the grill plate 18 itself can be supported horizontal to the lower housing 12 and the grilling ridges pattern of the grill plate 18 can instead create the slope and thus accommodate grease flow.

An upper grill plate 28 is likewise operatively connected with the upper housing 14. Plate 28 is preferably mechanically held in position to the upper housing 14 by means as are known in prior art designs to allow removable connection of the upper grill plate 28 to the upper housing 14 for cleaning. Mechanical spring clips 29 are shown in FIGS. 1 and 4 for this purpose.

FIG. 4 shows an example of a heating element 30 arranged and supported within the upper housing 14 to provide conductive heat transfer to the upper grill plate 28. Again, the heating element 30 is preferably a cal-rod type electrical resistance heating element, but could be any other conductive, convective and/or radiant heating element. The lower heating element 22 and the upper heating element 30 are preferably electrically connected with a temperature control circuit, the purpose of which is to supply electrical current to both heating elements as controlled minimally by a feedback temperature sensor of one or both of the grill plates 18 and 28.

FIG. 4 shows the upper grill plate 28 removed from the upper housing 14 and setting below it thus showing the backside of the upper grill plate 18. As described below with respect to the lower grill plate 18, the upper grill plate 28 preferably includes an integrally formed groove or channel 32 that is complimentary to the design of the upper heating element 30. This allows the upper heating element 30 to assist in proper positioning of the upper grill plate 28 to the upper housing 14. The groove or channel 32 also shields the heating element 30 from direct contact with grease that may splatter from the cooking food and enhances conductive heat transfer. No such structure as defining the channel 32 is required and the heating element may simply contact the backside of the grill plate 28, which itself may be flat or otherwise shaped such as by providing a raised surface that follows a similar pattern as the heating element 30. The same is true of the design of the lower grill plate 18 backside surface. If other type heating elements and heat delivery methods are utilized instead, the designs can also be varied to manage grease, enhance heat transfer, and/or grill plate location.

In this embodiment of the present invention, the upper grill plate 28 is provided with a pattern of through-openings 34. This pattern of openings 34 is arranged and sized to permit fluid flow (any combination of gas and liquids, potentially with solids in suspension) from a cooking chamber 36 (FIG. 1) to an internal volume 37 (FIG. 4) within the upper housing 14 above the upper grill plate 28. The openings are also arranged to accommodate the shape of the upper heating element 30 as the upper heating element is preferably positioned within the groove or channel 32, which shields the upper heating element 30 from contacting grease that may splatter or otherwise flow through the openings 34.

The cooking chamber 36 comprises a volume between the lower and upper housings 12, 14 that is formed when a food product is positioned on the lower grill plate 18 and the upper grill plate 28 is lowered to a contact position with the food product. The pattern of openings 34 may be varied in any number of ways with the understanding that it is desirable to create a fluid flow of some sufficiency so that smoke generated during cooking can travel at a desired quantitative level into the interior volume 37 of the upper housing for reasons as described below. The desired level is preferably based upon the quantity of smoke that is generated based upon a specific product, such as during the cooking of a set number of burgers at given cooking period. In any case, the openings 34 through the top grill plate 28 and into the interior volume 37 provide one example of an initial part of an upper air flow path.

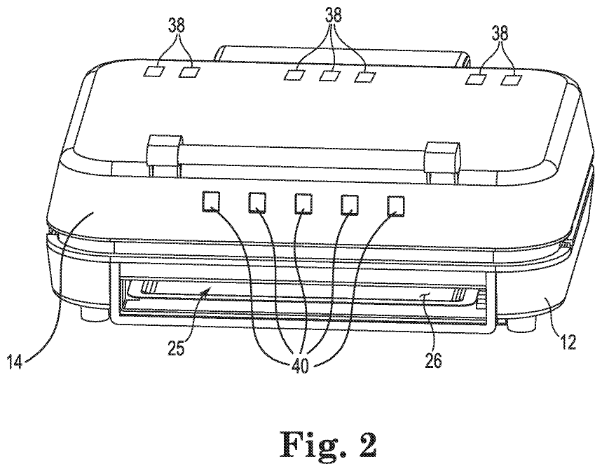

Referring to FIG. 2, the upper housing 14 also includes other features defining additional parts of the upper air flow path. Specifically, it is preferable to define a feature, such as openings 38, that allow fluid to pass from the internal volume 37 to the outside and another feature, such as openings 40, to allow additional fluid/air flow into the interior volume 37. By this arrangement, the upper flow path is created so that fluid (as comprising air and smoke which again may include gases, liquid and/or solids in suspension) can exit the cooking chamber 36 in a passive manner through the upper housing 14.

Specifically, the upper housing 14 is shown as including a series of exit openings 38 that are preferably arranged at the upper rear portion of the upper housing 14. These openings 38 are preferably at the highest point of the internal volume 37 for natural flow of heated gases upward. Like the openings in the upper grill 28, the number and size of the openings 38 are determined based upon the flow that provides the desired results of reducing visual smoke during cooking. These openings 38 allow the air/smoke generated from the cooking chamber 36 to exit from the internal volume 37.

Openings 40 also accommodate an additional air flow into the internal volume 37. A series of openings 40 are illustrated as an example in FIG. 2. These openings 40 are operatively positioned to be below the openings 38 based upon a use position of the upper housing 14 during a typical cooking operation and with a food product providing a cooking chamber 36 between the upper and lower grill plates 28 and 18, respectively. So, in addition to fluid flow from the cooking chamber 36 to and from the exit openings 38, additional air can flow from the inlet openings 40 to the exit openings 38.

The action of hot air/smoke from the cooking chamber 36 rising through the interior volume 37 of the upper housing 14 creates an air drawing affect at the openings 40. This dynamic activity pulls air into the internal volume 37 based on the rate of flow of hot gases through the internal volume 37 from openings 34 to the exit openings 38. Thus, the upper flow path is actually a combination of fluid flow from the cooking chamber 36 and fluid flow into and out of the internal volume 37 of the upper housing 14. The air flow into the internal volume 37 by way of the openings 40 increases the air quantity within the internal volume 37 and this additional air flow can dissipate smoke within the internal volume by mixing with the smoke and may also cool the smoke even potentially to the point of condensation of steam and/or grease.

The number, size, and shapes of the openings 38 and 40 can be varied like those openings 34 of the upper grill plate 28 to modify and control a desired upper flow path pattern. It is desirable in accordance with the present invention that at least the two air flow paths described above are created by natural passive gas flow as it is heated within the cooking chamber 37. Rising gases from the cooking chamber 37 cause smoke to be mixed within the internal volume 37 and the mixture thereof then through the exit openings 38. Outside air is drawn as well into the interior volume 37 by way of the openings 40 by the action of the rising gases.

It is also understood that air can also enter into the upper flow path from other sources. In the FIG. 1 embodiment, air can flow into the cooking chamber 36 by way of the front opening 25 and the grease slot 24. The action of rising gases from the cooking chamber 36 will also draw the air at the lower level. Likewise, air can enter the cooking chamber 36 from all around the edges potentially of the cooking chamber where there is any opening between the upper grill plate 28 and the lower grill plate 18 as a result of a food product between them. It is preferable to limit and/or control such side air flow into the flow system by including an overlap of the upper and lower housings 14, 12, as described below in certain examples of the present invention, but such is not necessary to achieve a reduction in visual smoke generation. Overlapping the upper and lower housings 14, 12 also keeps the smoke from escaping around the edges so that the smoke flows instead into the internal chamber 37.

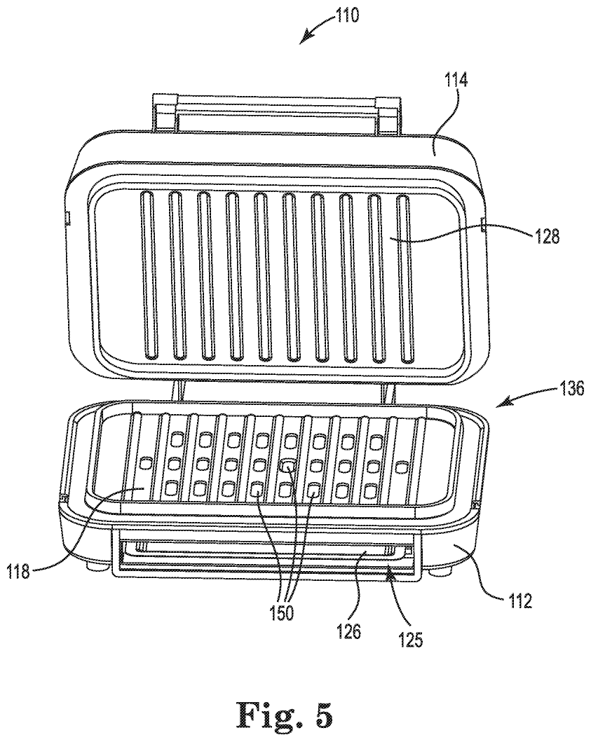

FIG. 5 shows another embodiment of a contact grill 110 of the present invention. This embodiment includes many similar features of the contact grill 10 and the similar components are not described again in detail. A lower housing 112 is hingedly connected with an upper housing 114. A lower grill plate 118 is operatively supported by the lower housing 112 and an upper grill plate 128 is operatively supported by the upper housing 114.

In this embodiment, the lower grill plate 118 includes a pattern of openings 150 that are strategically provided so as not to interfere with a lower heating element (not shown, but similar to that described above at 22). One purpose of these openings 150 is to allow grease generated during cooking to drip from the lower grill plate 118 to the drip pan 126 located within the lower housing 112 directly below the lower grill plate 118. The provision of a groove or channel on the backside of the lower grill plate, as discussed above, provides a shield for the heating element so that dripping grease does not contact the heating element.

The front of the lower housing 112 also preferably includes an opening 125 to permit air flow into the lower housing 112 and to also allow access to and removal and insertion of a drip tray 126 that can be operatively supported below at least the openings 150 of the lower grill plate 118 as shown. The drip tray 126 may otherwise be insertable and removable relative to the inside of the lower housing 112 by an access otherwise provided, such as at the sides or back of the lower housing 112.

Also according to this embodiment, the upper grill plate 128 is operatively supported to the upper housing 114, but the upper grill plate 128 is a solid grill plate without the provision of any openings for defining part of a fluid flow path through the upper housing as in the first embodiment described above. As such, the upper housing 114 need not be provided with other fluid flow path features, as are described above. A flow path for this embodiment would instead only comprise a lower flow path whereby air enters the system from below the lower grill plate, such as via the opening 125. Gas flow through the opening 125 is drawn into the inside of the lower housing 112 by the affect of rising heated gases within the cooking chamber 136. The heated gases would exit the contact grill in any open areas provided between the upper housing 114 and the lower housing 112 when a food product is present within the cooking chamber 136.

The drip tray 126 is preferably positioned sufficiently below the lower heating element to keep the temperature to a level below the point of causing grease to burn as a result of contact with the drip tray 126. It is preferably to keep the drip tray temperature below at least 170 degrees C., more preferably below 150 degrees C., and most preferably below 100 degrees C. In addition to the spacing of the drip tray 126 sufficiently below the heating element, the air flow of air drawn into the lower housing 112 also acts to cool the drip tray 126 and the grease itself as it drips from the lower grill plate 118.

Reducing the amount of grease as it could reside on the lower grill plate 118 reduces the amount of generated smoke. Less grease is burned on the lower grill plate 118. With the drip tray 126 temperature controlled as above, the grease will pool on the drip tray 126 without burning. As distinct from the design of the first embodiment, the provision of a pattern of openings 150 through the lower grill plate 118 allows the grease to travel directly downward and thus there is no need to have the cooking surface of the lower grill plate at an angle to cause grease drip flow to a front edge drip tray. The entire contact grill can have horizontal cooking nature.

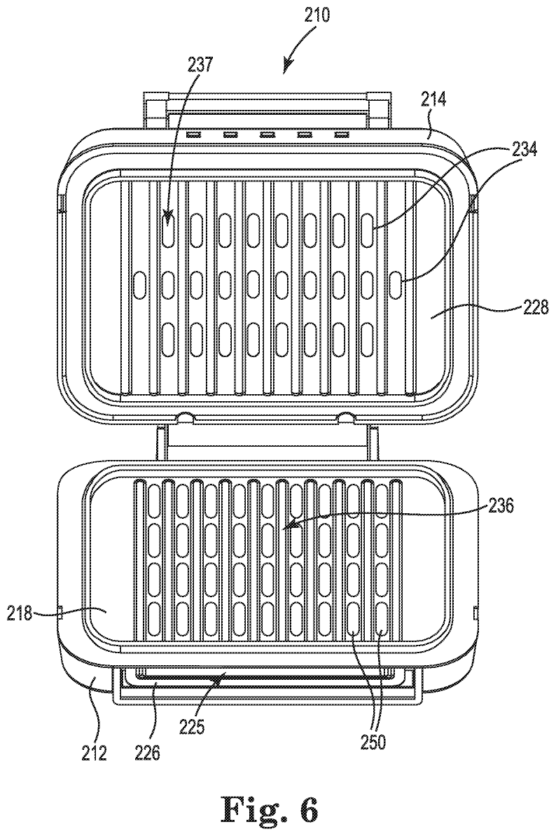

In FIG. 6, another embodiment of a contact grill 210 in accordance with the present invention is shown. This embodiment is a combination of the features of the previously described two embodiments. In essence, the lower flow path and upper flow path are combined so that heated gases from cooking passively create a full fluid flow path throughout the contact grill 210.

This embodiment also includes many similar features of the contact grill 10 and the similar components are not described again in detail. A lower housing 212 is hingedly connected with an upper housing 214. A lower grill plate 218 is operatively supported by the lower housing 212 and an upper grill plate 228 is operatively supported by the upper housing 214.

Like the second embodiment, the lower grill plate 218 includes a pattern of openings. 250 that are strategically provided so as not to interfere with a lower heating element (not shown, but similar to that described above at 22). One purpose of these openings 250 is to allow grease generated during cooking to drip from the lower grill plate 218 to the drip pan 226 located within the lower housing 212 directly below the lower grill plate 218. Again, the provision of a groove or channel on the backside of the lower grill plate, as discussed above, provides a shield for the heating element so that dripping grease does not contact the heating element. The front of the lower housing 212 also preferably includes an opening 225 to allow access to and removal and insertion of a drip tray 226 to be operatively supported below at least the openings 250 of the lower grill plate 218.

Like the first embodiment, the upper grill plate 228 is provided with a pattern of through-openings 234. This pattern of openings 234 is arranged and sized to permit fluid flow (any combination of gas and liquids, potentially with solids in suspension) from a cooking chamber 236 to an internal volume 237 within the upper housing 214 above the upper grill plate 228. The cooking chamber 236 comprises a volume between the lower and upper housings 212, 214 that is formed when a food product is positioned on the lower grill plate 218 and the upper grill plate 228 is lowered to a contact position with the food product.

The pattern of openings 234 and 250 of the upper and lower grill plates, respectively, may be varied in any number of ways with the understanding that it is desirable to create a fluid flow of some sufficiency so that smoke generated during cooking can travel at a desired quantitative level into the interior volume 237 of the upper housing 214. The desired level is preferably based upon the quantity of smoke that is generated based upon a specific product, such as during the cooking of a set number of burgers at given cooking period. As above, the openings 234 through the top grill plate 28 and into the interior volume 37 provide one example of an initial part of an upper fluid flow path.

The features of the upper housing 214 as including exit openings 38 and inlet openings 40, as described above and shown in FIG. 2, are preferably similarly utilized in this embodiment. These features create the upper fluid flow path in the same manner as described above. Moreover, the lower fluid flow path as also described above is created. In this case, the fluid flow to the upper flow path is sourced primarily by the lower fluid flow path via the front opening 225, the inside of the lower housing 212, and the openings 250.

The advantages of the above described embodiments are thus also combined. Less burning of grease by the lower grill plate 218 is advantageous in creating less smoke, and the upper fluid flow path reduces the creation of visible smoke exiting the contact grill 210. The same mechanisms as described above apply equally here. A full passive fluid flow path and system is thus created by the contact grill 210.

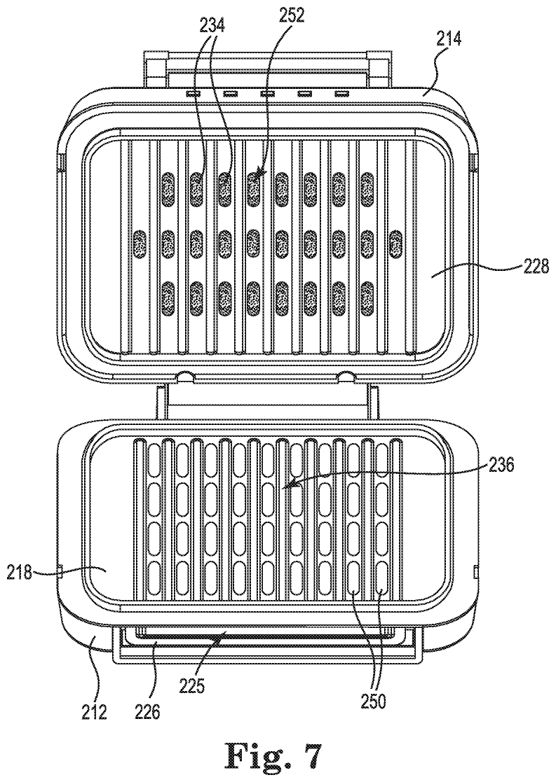

FIG. 7 also shows the contact grill 210 but further including a filter element 252 provided within the structure of the upper housing 214. The filter element can be a mat or sheet of filter material and can be positioned above the backside of the upper grill plate 228 and thus also the heating element and partially within the interior volume of the upper housing 214. Multiple filters can be utilized in an arrangement or overlying one another. For example, a filter element can be arranged at each opening 234 instead of one covering all of the openings 234. Such a filter material should be of a material, such as aluminum, other metals, ceramics, plastics, or any other material that is capable of trapping grease or other particulates and that is capable of withstanding the temperatures of the environment. As above, grease in the form of droplets or particles of liquid or solid that may be travelling along the upper fluid flow path of the upper housing 214 are preferably removable by such a filter element 252. The filter element 252 also preferably has a sufficient open area to allow the air flow that is desired along the upper flow path. Also, the one or more filter elements 252 are preferably removable and cleanable or replaceable.

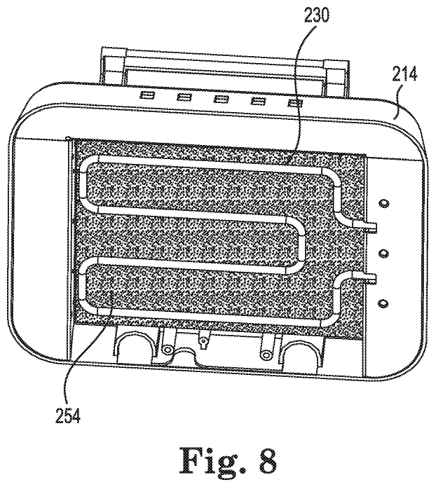

FIG. 8 shows a similar construction as FIG. 7 but without a top grill plate 228. The upper heating element 230 is shown as positioned within the upper housing interior volume 237 and between where the top grill plate 228 would be supported and a screen-type filter assembly 254 that is supported to the upper housing 214. In this case, the screen filter 254 extends substantially over the open portion of the upper housing 214, but what is important is that the filter 254 be positioned within the upper fluid flow path of the upper housing 214.

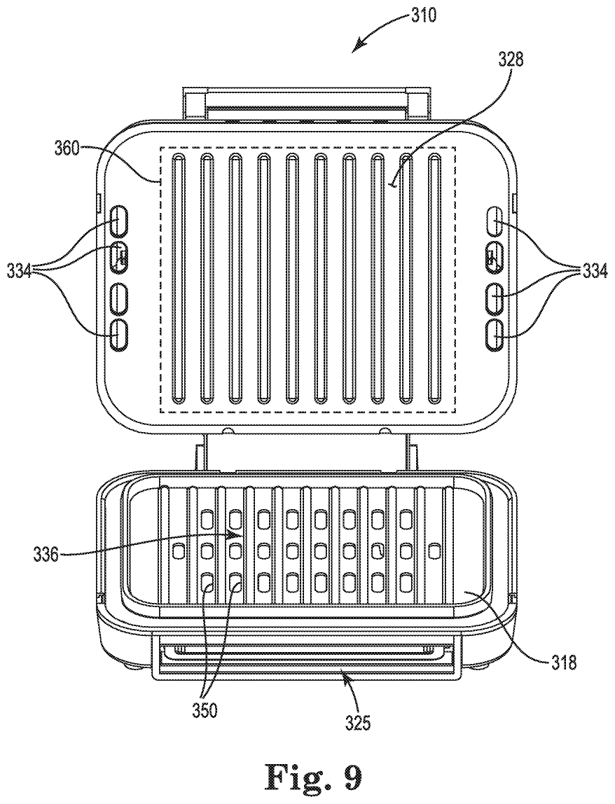

A modified version of the contact grill 210 of FIG. 6 is illustrated in FIG. 9. The same principles apply to this embodiment and the designs are similar with the exception of the openings 334 as provided through the upper grill plate 328. As can be seen, the openings are provided toward two sides of the upper grill plate 328 instead of in a pattern of the upper grill plate.

Essentially, in this embodiment, it is further desirable to position the openings 334 outside of a cooking contact zone 360 of the upper grill plate 328. The openings 334 preferably provide the desired fluid flow volume and rate that is determined to be beneficial to reduce visible smoke from the contact grill 310, as discussed above. But, by positioning the openings 334 outside the cooking contact zone 360, grease that splatters directly from the food product will not be able to directly pass through any one of the openings 334, as could happen with the openings 234 described above. Moreover, the placement of one or more food products within the cooking contact zone will not interfere with the fluid flow into the openings 334.

The cooking contact zone 360 is generally a more central portion of the upper grill plate that preferably coincides with the grill pattern of the lower grill plate 318 and its pattern of openings 350. Upper grill plate 328 is shown without cooking ribs, but such ribs can be provided in any grill pattern as desired, which ribs would be provided substantially within the cooking contact zone as an indicator of where the food product(s) should be positioned for cooking.

It is also contemplated that the openings 334 need not be provided through the upper grill plate 328. Instead, the upper housing could include a peripheral, or partially peripheral, section around at least part of an upper grill plate 328 that fits within the section. The openings 334 could be provided in one or more areas of the peripheral section of the upper housing 314 instead. In this case, the whole upper grill plate 328 could then define the cooking contact zone.

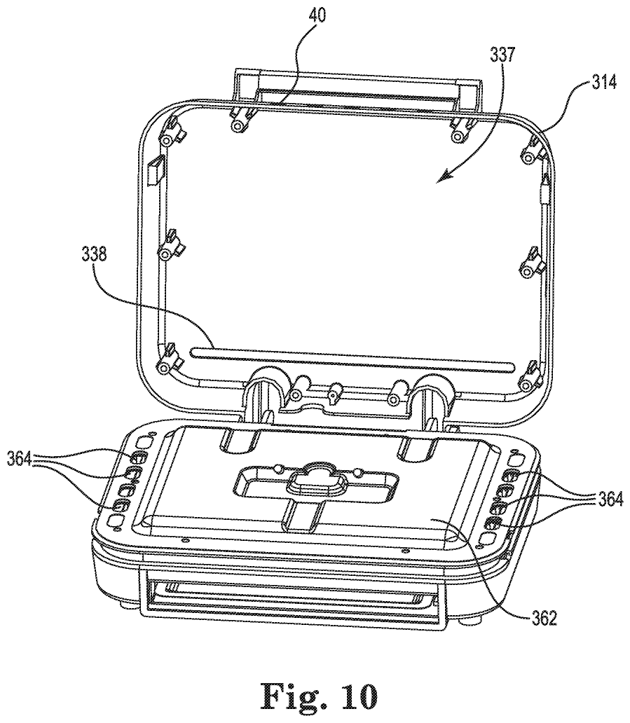

FIG. 10 shows an additional feature that can be added into any of the embodiments of the present invention, but shown as a feature of the upper housing 328 of FIG. 10. A heat shield 362 can be provided to reflect heat from a heating element like that shown at 230 toward the backside of the upper grill plate 328 and to keep the top of the upper housing 328 cooler. The heat shield can be attached to the upper housing 314, for example at points along its periphery by conventional means such as metal screws. In order to allow the fluid flow into the internal volume 337 of the upper housing from the openings 334 of the upper grill plate 328, similarly arranged and sized openings 364 are preferably provided through the heat shield 362.

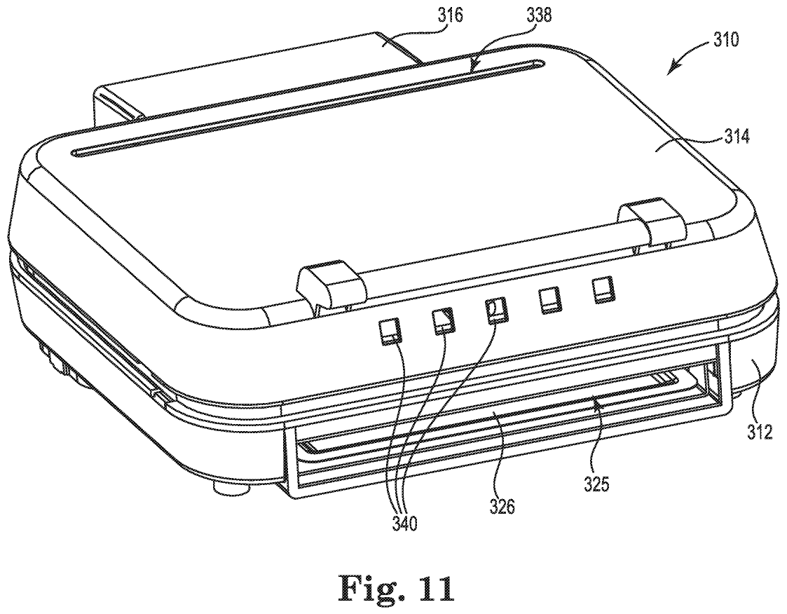

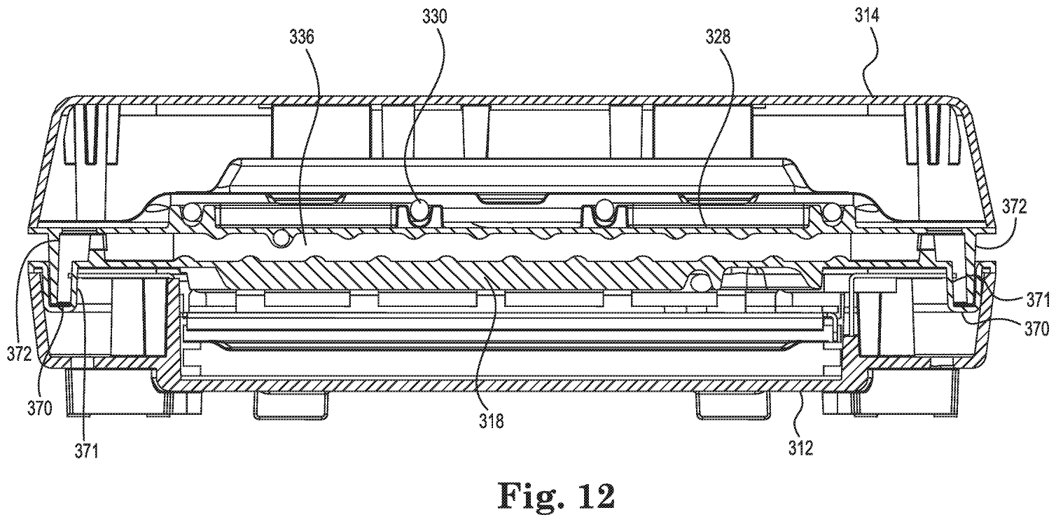

FIG. 11 is a perspective view of the contact grill of FIGS. 9 and 10 comprising the lower housing 312 and upper housing 314 connected together by a hinge assembly 316. The upper housing 314 is shown with intake vents 340 and exit opening 338, shown as a single elongate opening instead of a series of openings as at 38, described above. The lower housing is shown with a front opening 325 within which a drip tray 326 is also operatively supported. The upper heating element 330 is shown in FIG. 12 engaged within a receiving groove of the backside of the upper grill plate 328.

The contact grill 310 is shown in a closed state. Specifically, the upper housing 314 is positioned on top of the lower housing 312 with the grill sides being designed to create a barrier to air flow into the cooking chamber 336. The design of the upper and lower housings preferably create a partial cooking chamber therein in a closed state as shown in FIG. 12. In this closed state, the cooking chamber 336 is partially provided as defined between the upper grill plate 328 and the lower grill plate 318. It is contemplated, however, that the upper grill plate 328 could instead rest against the lower grill plate 318.

To provide a partial cooking chamber 336, the upper housing 314 is preferably spaced somewhat from the lower housing 312 by structure that can extend from the grill plates 318, 328, or from the housings themselves 312, 314. It is more preferable that the spacing structure also provides a sliding fluid barrier structure that substantially keeps the sides, front and back around the contact grill 310 from opening to external of the grill even as the cooking chamber 336 is increased, such as by the thickness of any food product put into the cooking chamber 336. By doing so, air flow into the cooking chamber 336 is controlled as desired, such as by way of a front access opening 325 and lower plate openings 336. Moreover, the fluid flow path of the smoke from the cooking chamber 336 is controlled as desired, such as by way of the upper plate openings 334 and exit opening(s) 338.

FIG. 12 illustrates an example where a sliding barrier is created by peripheral portions of the upper and lower grill plates 328, 318. Lower grill plate 318 in FIG. 12 includes a peripheral recess 370 that extends below the level of the top surface of the lower grill plate 318. A sidewall 371 spaces the recess 370 downward. The upper grill plate 328 is shown in this case with a downwardly depending peripheral extension element 372. The distal end of the peripheral extension element 372 abuts the recess 370 when the grill is in the closed position to preferably partially provide the cooking chamber 336. The partially created cooking chamber 336 is preferably thinner than any expected food item expected to be cooking in the contact grill 310. However, as the cooking chamber 336 is increased, such as by putting a thicker food product within the cooking chamber 336, the extension element 372 will move or slide along the sidewall 371 of the recess 370 until the increase in size of the cooking chamber 336 is greater than the dimension of the sidewall 371 as such extends to the recess 370 from the cooking surface of the lower grill plate 318.

This construction is but one example of a sliding barrier that helps control air flow into the cooking chamber 336 during cooking. As above, it is preferable to control the fluid flow throughout the contact grill 310, i.e. through the lower housing 312, the cooking chamber 336, and the upper housing 314, for controlling smoke reduction and dissipation. Similar extension structures to create a sliding barrier can easily be provide a components of the upper and lower housings 312, 314, instead. Other structure for creating a sliding fluid barrier can be provided by external components, or otherwise.

Each of the above described and suggested embodiments of the present invention result in a reduction of visible smoke by a contact grill during cooking. Each of the embodiments of FIGS. 1-4, FIG. 5, FIGS. 6-8, and 9-12 were tested empirically within a lab by cooking two burgers of even size and shape and comprising 20% fat content for a similar period. The cooking process was visibly observed in each case to verify smoke generation during the cooking process. The cooking processes utilizing the contact grills of FIGS. 1-4 and FIG. 5 showed an improvement in visible smoke generation over the smoke generation of a non-modified grill that comprised a prior art grill that is commercially available as the George Foreman® contact grill model number GRP1060B. With these two embodiments, less smoke was observed as compared to the non-modified grill, but the smoke generation was deemed to yet be moderate by visual observation.

The contact grills of FIGS. 6-8 and 9-12 were similarly tested. These units share in common the control of fluid flow through both the lower and upper housings along with the cooking chamber. Each of these grills combine the benefits of the grease removal through the lower grill plate to the grease tray and fluid flow from the lower housing through the cooking chamber and through the upper housing as described above. Both of these units exhibited what was characterized as minimal visible smoke generation over the entire cooking process.

Other quantifiable test methods have also been developed to measure the presence of smoke. For example, the contact grills of the present invention were placed within a closed environment and run through a similar cooking process as described above. In each case, a 1 mW, 650 nm wavelength laser was positioned above and to one side of the grill and directed to a photodiode (model BPW21) positioned on the other side of the grill. The laser was kept on and measured during the entire cooking process so as to measure the amount of smoke generated within the controlled environment. The amount of light scattered or absorbed by the smoke is linearly proportional to amount of smoke generated. Laser arrangements of this type have been developed in other industries for measuring particulates such as emission detection, fire alarms, and indoor air quality detectors.

Other electronic detectors are commercially available, such as the Dust Trak II™ aerosol monitor available from TSI, Incorporated of Shoreview, Minn. This device uses a 90° light scattering sensor to detect particulate concentration of a selected size and below.

In the above described embodiments of the present invention, fluid flow paths are provided, which fluid flow through the flow paths is primarily passive fluid flow caused by the convective action of heated air rising within and out of the defined structure. The ability to reduce production of and the visibility of smoke is advantageously attained without the need for air flow assist from other means, such as one or more fans. It is, however, contemplated that an air flow assist feature could supplement the fluid flow within and from the contact grill of the present invention. One or more fans could supplement air flow and could be mounted within or attached to either or both of the upper and lower housings. A fan could provide positive air flow to push air through the lower and/or upper housings, or could utilize negative pressure to pull air through the lower and/or upper housings.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A contact grill comprising:
a lower housing including a lower grill plate and a lower heating element for controlled heating of the lower grill plate, the lower heating element electrically connected with a temperature control circuit;
an upper housing including an upper grill plate and an upper heating element for controlled heating of the upper grill plate, the upper heating element electrically connected with the temperature control circuit; and
a hinge operatively connecting the lower and upper housings and permitting movement of the lower and upper housings relative to one another for allowing one or more food items to be placed in contact with the lower and upper grill plates and creating a cooking chamber;
the upper housing being vented to permit fluid flow there-through from the cooking chamber to external of the upper housing, the upper housing comprising at least one exit opening from an internal volume between the upper grill plate and the upper housing, a least one air inlet opening positioned lower than the exit opening, and at least one opening allowing fluid flow from the cooking chamber into the upper housing chamber.

2. The contact grill of claim 1, wherein during a cooking cycle, the opening from the cooking chamber into the internal volume of the upper housing allows passive flow of heated fluid from the cooking chamber into the internal volume of the upper housing and subsequently fluid flow from the internal volume by way of the exit opening as a first upper fluid flow path and further wherein the fluid flow through the internal volume of the upper housing passively draws ambient air into the internal volume of the upper housing by way of the inlet opening thus creating a second upper fluid flow path.

3. The contact grill of claim 2, wherein the fluid flow of the heated fluid from the cooking chamber into the internal volume of the upper housing also causes a fluid flow into the cooking chamber.

4. The contact grill of claim 3, wherein the lower housing includes an access opening into the inside of the lower housing and the lower grill plate includes at least one opening so that a lower fluid flow path is created by passively drawing air into the cooking chamber.

5. The contact grill of claim 1, comprising plural openings from the cooking chamber into the internal volume of the upper housing, the plural openings arranged outside of a cooking contact zone of the upper grill plate.

6. The contact grill of claim 5, comprising plural exit openings and plural inlet openings of the upper housing, wherein each of the exit openings are positioned above each of the inlet openings.

7. The contact grill of 1, wherein the upper grill plate includes a pattern of openings provided through the upper grill plate.

8. The contact grill of claim 7, wherein the lower grill plate includes a pattern of openings provided through the lower grill plate.

9. The contact grill of claim 1, further including a sliding barrier between the upper and lower housings for limiting air flow into the cooking chamber from the front, sides, and back of the contact grill, the sliding barrier comprising an extension element from one of the upper and lower grill plates or housings and a recess element from the other of the upper and lower grill plates or housings so that air flow is restricted over a range of separation of the upper and lower grill plates from one another.

10. A contact grill comprising:
a lower housing including a lower grill plate and a lower heating element for controlled heating of the lower grill plate, the lower heating element electrically connected with a temperature control circuit;
an upper housing including an upper grill plate and an upper heating element for controlled heating of the upper grill plate, the upper heating element electrically connected with the temperature control circuit; and
a hinge operatively connecting the lower and upper housings and permitting movement of the lower and upper housings relative to one another for allowing one or more food items to be placed in contact with the lower and upper grill plates and creating a cooking chamber;
the lower housing including an access opening to the inside of the lower housing and the lower grill plate including at least one opening so that air can flow into the lower housing and out from the opening of the lower grill plate into the cooking chamber, the lower housing also including a drip pan removably located therein.

11. The contact grill of claim 10, wherein the upper housing is vented to permit fluid flow there-through from the cooking chamber to external of the upper housing, the upper housing comprising at least one exit opening from an internal volume between the upper grill plate and the upper housing, a least one air inlet opening positioned lower than the exit opening, and at least one opening allowing fluid flow from the cooking chamber into the upper housing chamber.

12. The contact grill of claim 11, wherein during a cooking cycle, the opening from the cooking chamber into the internal volume of the upper housing allows passive flow of heated fluid from the cooking chamber into the internal volume of the upper housing and subsequently fluid flow from the internal volume by way of the exit opening as a first upper fluid flow path and further wherein the fluid flow through the internal volume of the upper housing passively draws ambient air into the internal volume of the upper housing by way of the inlet opening thus creating a second upper fluid flow path.

13. The contact grill of claim 12, wherein the fluid flow of the heated fluid from the cooking chamber into the internal volume of the upper housing also causes a fluid flow into the cooking chamber.

14. The contact grill of claim 13, wherein the lower housing includes an access opening into the inside of the lower housing and the lower grill plate includes at least one opening so that a lower fluid flow path is created by passively drawing air into the cooking chamber.

15. The contact grill of claim 11, comprising plural openings from the cooking chamber into the internal volume of the upper housing, the plural openings arranged outside of a cooking contact zone of the upper grill plate.

16. The contact grill of claim 15, comprising plural exit openings and plural inlet openings of the upper housing, wherein each of the exit openings are positioned above each of the inlet openings.

17. The contact grill of 11, wherein the upper grill plate includes a pattern of openings provided through the upper grill plate.

18. The contact grill of claim 17, wherein the lower grill plate includes a pattern of openings provided through the lower grill plate.

19. The contact grill of claim 11, further including a sliding barrier between the upper and lower housings for limiting air flow into the cooking chamber from the front, sides, and back of the contact grill, the sliding barrier comprising an extension element from one of the upper and lower grill plates or housings and a recess element from the other of the upper and lower grill plates or housings so that air flow is restricted over a range of separation of the upper and lower grill plates from one another.

20. A contact grill comprising:
a lower housing including a lower grill plate and a lower heating element for controlled heating of the lower grill plate, the lower heating element electrically connected with a temperature control circuit;
an upper housing including an upper grill plate and an upper heating element for controlled heating of the upper grill plate, the upper heating element electrically connected with the temperature control circuit; and
a hinge operatively connecting the lower and upper housings and permitting movement of the lower and upper housings relative to one another for allowing one or more food items to be placed in contact with the lower and upper grill plates and creating a cooking chamber;
the upper housing being vented to permit fluid flow there-through from the cooking chamber to external of the upper housing, the upper housing comprising at least one exit opening from an internal volume between the upper grill plate and the upper housing, a least one air inlet opening positioned lower than the exit opening, and at least one opening allowing fluid flow from the cooking chamber into the upper housing chamber,
the lower housing including an access opening to the inside of the lower housing and the lower grill plate including at least one opening so that air can flow into the lower housing and out from the opening of the lower grill plate into the cooking chamber, the lower housing also including a drip pan removably located therein.
